(19) United States
(12) Patent Application Publication
(10) Pub. No.: US 2006/0087673 A1
(43) Pub. Date: Apr. 27, 2006

(54) Apparatus, method and program for image processing on ground pattern

(75) Inventor: Toshikazu Kawaguchi, Kobe-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/024,640

(22) Filed: Dec. 30, 2004

(30) Foreign Application Priority Data
Oct. 21, 2004 (JP) 2004-307132

(51) Int. Cl. G06K 15/00

(52) U.S. Cl. 358/1.14

(57) ABSTRACT

in image processing, a ground pattern is detected in an input image and regions are separated in the image data in accordance with a feature of the input image. Then, the ground pattern is edited based on the detected ground pattern and the result of region separation so as not to deteriorate the input image. Preferably, the ground pattern is detected in the input image data, and the detected ground pattern is edited.

This application is based on application No. 2004-307132 filed in Japan, the contents of which are hereby incorporated by reference.

### BACKGROUND OF THE INVENTION

1. Field of the Invention

The present invention relates to prevention of illegal copy of an important document, a secret document or the like with an image forming apparatus.

2. Description of the Related Art

Recently, electrophotographic copying machines have been spread widely, and characters or an image printed on a sheet of paper or the like can easily be copied by any person by using such a copying machine. Image processing technology and image forming technology are also improved significantly. Then, especially, by using a state of the art digital color copying machine (MFP), a copy difficult to be distinguished from an original can be created easily. Therefore, it is important to prevent forgery, falsification or illegal copying of prints of important documents.

In one of measures for preventing the forgery, falsification or illegal copying of these prints, a design mainly including a geometric pattern is added to a document image, and a latent image which cannot be recognized visually but included in the design becomes visible when an operation for print,. Its representative example is to use a pattern such as a ground image, a color pattern, or a relief pattern, used widely for securities and the like. Hereafter, the pattern is generally referred to as ground pattern. For example, in copying machines disclosed in Japanese Patent laid open Publication Nos. 164739/1997 and 231384/1995, in order to enhance the deterrent effect for the reproduction of a document for restraining a copy of the important document or a secret document, when an original print is produced, a ground pattern including a latent image and a ground image is synthesized and printed on the ground of an original image. When the original print is copied, the ground image is vanished subjected to a function such as ground removal by use read resolution limit of the scanning function when the original print is scanned. Then, the latent image such as characters of “COPY” becomes visible in the copy, and it becomes apparent with naked eyes that the copy is not an original.

In the above-mentioned copying machine, the deterrent effect for illegal copy is expected by making the latent image visible with naked eyes in a copy. However, because the image in a copy is a reproduction of the original image, the ground pattern may not become manifest in dome types of the image, or a part of the ground pattern may be incorporated in the image and become invisible. In such cases, the ground pattern cannot be noticed visually, and the deterrent effect or visualizing effect is deteriorated.

On the other hand, it is proposed to print only a ground pattern without reproducing the image itself (Japanese Patent laid open Publication No. 201068/2000). In this case, however, it is inherently impossible to trace what an original is copied. Further, it is impossible for a legitimate person to copy the original in order to distribute the copies.

### SUMMARY OF THE INVENTION

It is an object of the present invention to provide image processing capable of showing a ground pattern in a copy without deteriorating the quality of an image to be synthesized with the ground pattern when the image is read, reproduced and outputted.

In the image processing of the invention, an image data is inputted, and regions are separated in the image data in accordance with a feature of the input image. Then a ground pattern to be added to the image data is edited accordance with region information on each of the separated regions.

It is an advantage of the invention to prevent deterioration of an image by adding a ground pattern in a blank region or in a region in which an effective image is present when the region includes many white portion.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a block diagram of a multi-functional peripheral;

FIG. 2 is a diagram of an image processing blocks;

FIG. 3 is a diagram for explaining the ground pattern edition of an original having many blank spaces;

FIG. 4 is a flow chart for the ground pattern edition in a first embodiment;

FIG. 5 is a block diagram of the ground pattern editor;

FIG. 6 is a flowchart of the ground pattern edition in a second embodiment;

FIG. 7 is a block diagram of the ground pattern editor;

FIG. 8 is a diagram of a system in which a computer is connected with printers and the like;

FIG. 9 is a block diagram of a computer; and

FIG. 10 is a flowchart for the ground pattern edition in a third embodiment.

### DETAILED DESCRIPTION OF THE PREFERRED EMBODIMENTS

Referring now to the drawings, wherein like reference characters designate like or corresponding parts throughout the several views, embodiments of the present invention will be described below.

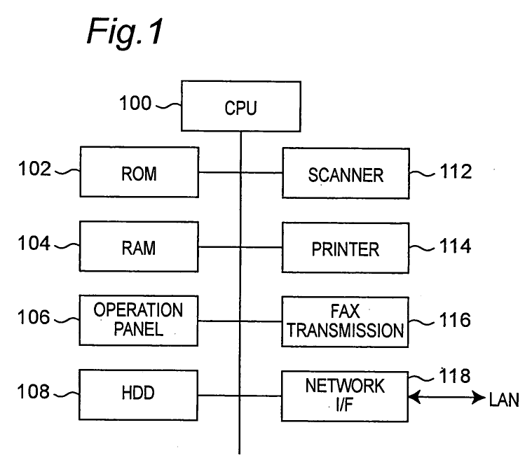

In a system having a multi-functional peripheral (MFP) which functions as a printer, a scanner and a copying machine is connected to an information processing terminal such as a computer through a network such as a local area network, a user of the information processing terminal can instruct read, print or the like of an image through the network. FIG. 1 shows a configuration of the MFP wherein a central processing unit (CPU) 100 for controlling the entire device is connected a read-only memory (ROM) 102, a random access memory (RAM) 104, an operation panel 106, a hard disk drive 108, and a network interface 118. Moreover, the CPU 100 is connected to a scanner 112 for reading an image, a printer 114 for printing, and a facsimile unit 116 for FAX transmission.

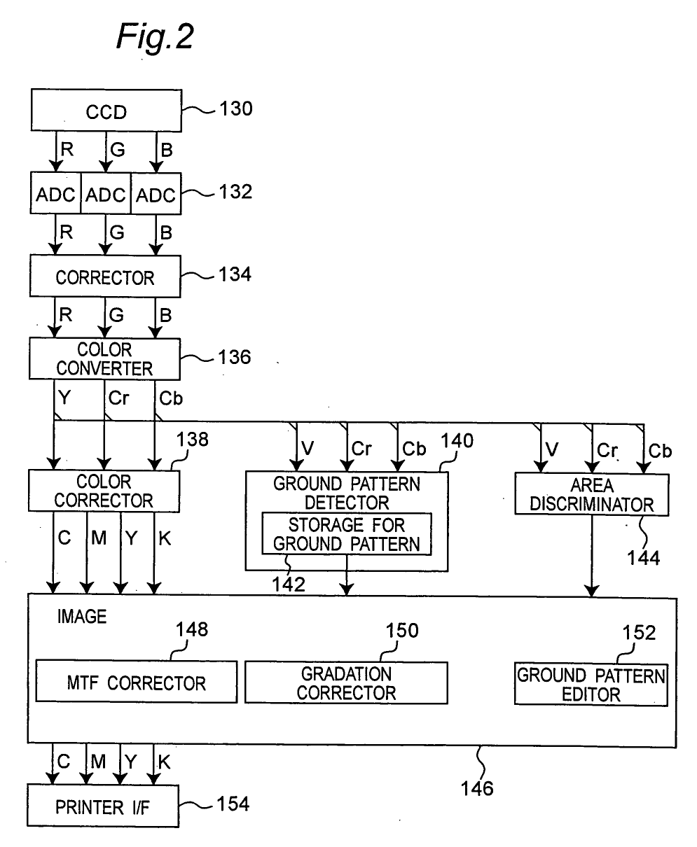

FIG. 2 shows an image processing block in the scanner 112 in the MFP. In the image processing block, a charge-coupled device (CCD) sensor 130 reads an image of an object in colors of R, G and B, and an analog-to-digital (A/D) converter 132 converts the RGB analog image data read by the CCD sensor 130 to digital data. Further, a correction unit 134 performs shading correction, chromatic aberration correction and the like for the digital data R, G and B, and if necessary changes the magnification of the image or moves the image. A color converter 136 converts the input image data expressed in RGB color space to image data expressed in VCrCb color space. Then, a color corrector 138 converts and corrects the image data in the VCrCb color space, to output image data (CMYK data) expressed in CMYK color space required for printing. An area discriminator 144 discriminates areas such as a photograph area, a character area and the like in the image. A ground pattern detector 140 detects a ground pattern by using data such as parameters or character patterns stored in a ground pattern storage device 142. In the detection of a ground pattern, a known technique may be used. For example, a ground region is separated from an image region, and it is compared with characteristic parameters of a ground pattern such as a color average value or a brightness histogram stored previously, and when a difference between them is found in a predetermined range, the ground region is decided to have a ground pattern. Another method disclosed in Japanese Patent laid open Publication No. 2004-201068 can also be used. Then, in an image corrector 246, a MTF corrector 148 performs MTF correction for the CMYK data depending on the region discrimination result by the area discriminator 144, and a gradation corrector 150 performs gradation correction. A ground pattern editor 152 edits the ground pattern. A printer interface 154 transmits the CMYK data subjected to the corrections and the edition to the printer 214.

A ground pattern denotes a pattern added in a background of a document in which dots, lines, a design or characters are repeated. Previously, a ground pattern is added to the whole image to be printed. However, in the ground pattern edition of the present invention, regions are separated in accordance with a feature of the input image of a document, and it is detected in the input data whether a ground pattern is present or not in a ground region. Further, image regions are detected in the input data other than the ground region, and the ground pattern is added to each image region so as not to change the quality of the original image by taking the information on each region (region information) such as a region size and a blank space into account.

In the detection of ground pattern, in the ground pattern detector 140, a ground region is separated from the other region in the input image data, and by analyzing the ground region, it is detected whether a ground pattern registered previously is present or not in the ground region. Moreover, the region are separated in accordance with a feature or features in the input image determined by the region discriminator 144, and characters regions, blank spaces and the like are discriminated in the input image. The result of the region separation includes the size of the blank space, the size of each image region in which an effective image is present, and an effective pixel (dot) ratio in each image region. Then, the ground pattern editor 152 edits the ground pattern so as not to deteriorate the quality of the original image in accordance with the detected ground pattern and the result of the region separation.

In a first embodiment of the invention, the result of the region separation to be considered includes blank space size, image region size, and effective pixel ratio in an image region. A certain degree of blank space is necessary to emphasize a ground pattern visually. Therefore, when an image region includes many blank spaces, the as-detected ground pattern is directly printed in the blank space. Moreover, if the image region with many blank spaces has a large image region size, when the effective pixel ratio in the image region is equal to or smaller than a predetermined ratio (a threshold value), the detected ground pattern is formed in the image region with a decreased density of the ground pattern. That is, the density of the ground pattern is changed in the image region to be overlapped with the ground pattern. However, when the effective pixel ratio in the image region is larger than the predetermined ratio (for example, when characters are fully written in the region), the ground pattern is not added to the image region. That is, the ground pattern is not added when the effective pixel ratio is large, even if the region is an image region. Further, the ground pattern is not added to an image region having a small effective pixel ratio. When the blank space size is small, the ground pattern density is decreased while it is inverted in the image portion.

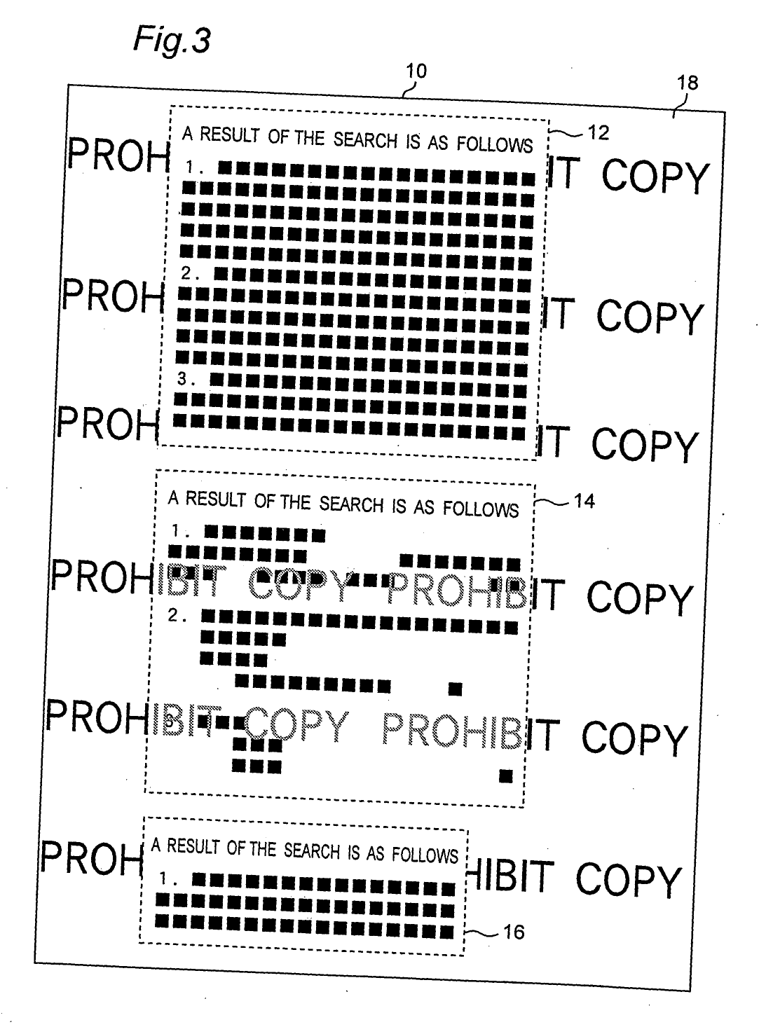

FIG. 3 shows an example of the ground pattern edition for an original 10 or a document including many blank spaces. Three characters regions 12, 14, and 16 (shown with enclosing broken lines in FIG. 3) and a blank space portion 18 are separated in the original 10. The size and effective pixel ratio of each of the regions 12, 14, and 16 are compared with predetermined threshold values. The characters of a phrase “PROHIBIT COPY” for deterring illegal copy are detected as a ground pattern in the blank space 18. When there are many blank spaces 18, the ground pattern detected is printed in the blank space portion. The characters region 12 having a large region size includes many characters (schematically shown by solid squares) and has a large effective pixel ratio. In this case, the ground pattern is not printed in the characters region. On the other hand, the characters region 16 has a small region size. In this case, the ground pattern is not printed in the characters region. Further, because a region size is large but the number of characters is small in the characters region 14, the detected ground pattern is printed in the characters region 14. In this case, the ground pattern is printed by decreasing the density of the ground pattern so that characters become visible even if the characters overlap with the ground pattern. The above-mentioned ground pattern edition is performed to prevent the deterioration of the quality of the image. In a device for embedding an electronic watermark disclosed in Japanese Patent laid open Publication No. 2003-209676, secret information is embedded partially in a region not overlapping with a characters region. On the contrary, in the above-mentioned ground pattern edition of the invention, a ground pattern is added to overlap with a characters region. Moreover, as described later, even for a characters region, the ground pattern is not added if the effective pixel ratio is large.

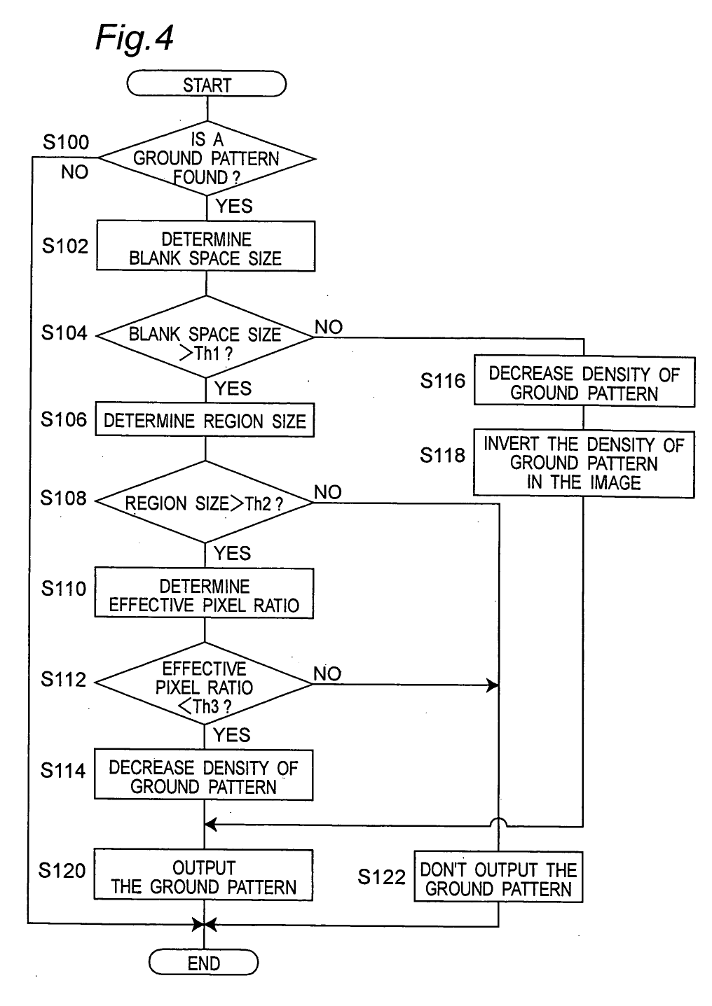

FIG. 4 shows a flow of the ground pattern edition in the ground pattern editor 152. When it is determined by the ground pattern detector 142 that there is a ground pattern (YES in S100), the blank space size is determined in accordance with the discrimination information from the region discriminator 144 (S102), and it is decided whether the blank space size is larger than a threshold value Th1 (S104). When the blank space size is larger than the threshold value Th1, the image region size is determined in accordance with the discrimination information from the region discriminator 144 (S106). When the image region size is larger than a threshold value Th2 (YES in S108), effective pixel ratio is determined in accordance with the discrimination information from the region discriminator 144 (S110). When the effective pixel ratio is smaller than a threshold value Th3 (YES in 112), the density of the ground pattern is decreased (S114), and the ground pattern is output (S120). When the effective pixel ratio is equal to or larger than the threshold value Th3 (NO in S112), the ground pattern detected by the ground pattern detector 142 is not output (S122). Moreover, when the region size is smaller than the threshold value Th2 (NO in S108), the ground pattern detected by the ground pattern detector 142 is not output in the image region (S122). Furthermore, if the blank space size is smaller than the threshold value Th1 (NO in S104), the density of the ground pattern detected by the ground pattern detector 142 is decreased (S116), and the ground pattern density in the image portion is inverted (S118). Then, the ground pattern is output (S120). In order to detect blank spaces, it is possible to use various known techniques, such as disclosed in Japanese Patent laid open Publication Nos. 5-316331/1993 and 2004-215122.

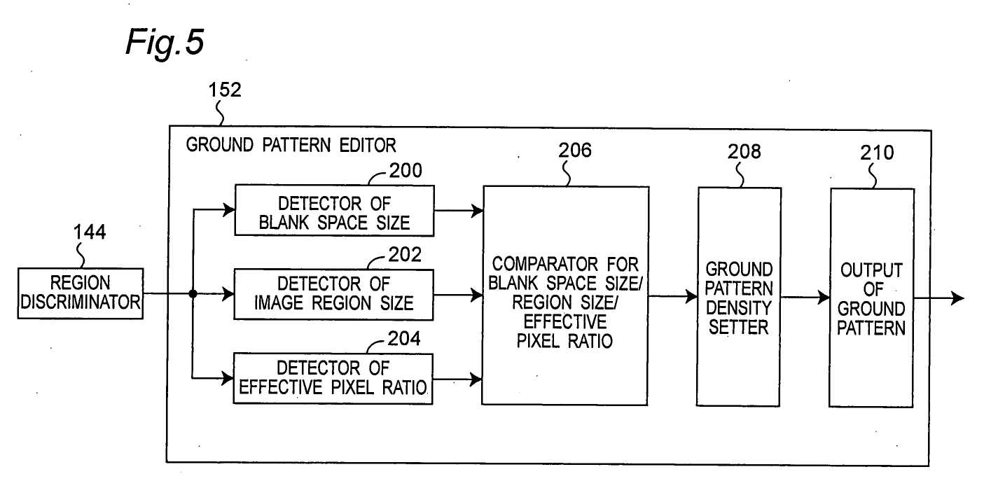

FIG. 5 shows a configuration of the ground pattern editor 152 for performing the processing shown in FIG. 4. A blank space size detector 200, an image region size detector 202, and an effective pixel ratio detector 204 determine the blank space size, the image region size, and the effective pixel ratio from the region determination results received from the region discriminator 144, respectively. A blank space size/image region size/effective pixel ratio comparator 206 receives the bland space size, the image region size, and the effective pixel ratio, and compares these values with the threshold values Th1, Th2, and Th3 previously set, respectively, to output the comparison results. A ground pattern density setter 208 converts and sets the density of the ground pattern if necessary. A ground pattern outputter 210 outputs the ground pattern when the predetermined condition is satisfied in accordance with an instruction from the comparator 206. In the image corrector 146, the image is corrected by using the result of the edition by the ground pattern editor 152.

Next, a second embodiment of the invention is explained wherein the blank space size and the period of the ground pattern are considered as the region separation results. When the blank space size is large and the ground pattern period is larger than the blank space size, the ground pattern period is set according to the blank space size.

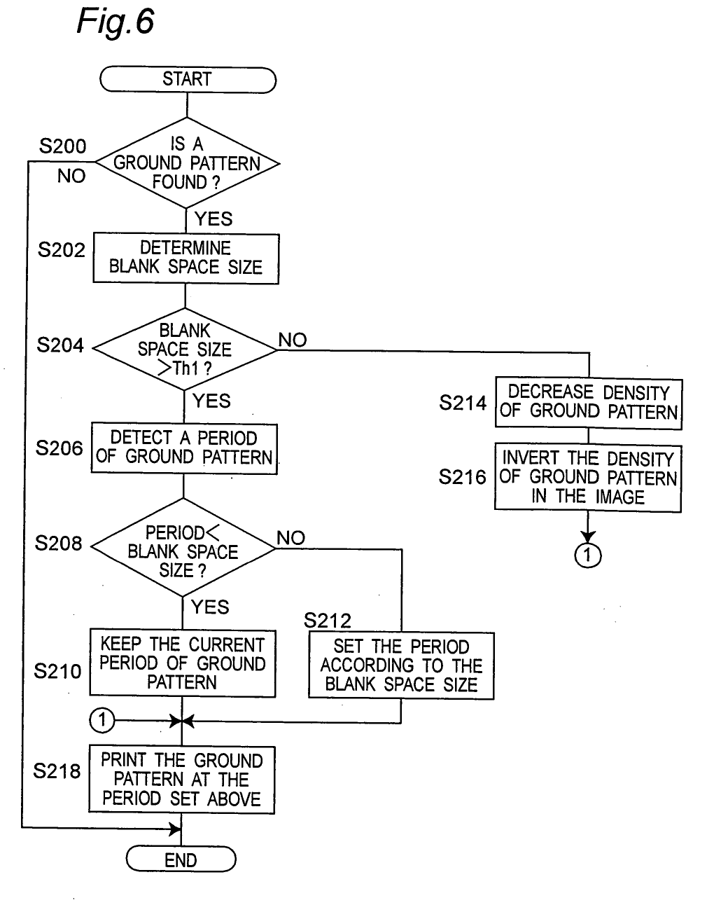

FIG. 6 shows a flowchart for the ground pattern edition in the second embodiment. When it is determined by the ground pattern detector 142 that there is a ground pattern (YES at S200), the blank space size is determined in accordance with the determination information from the region discriminator 144 (S202), and it is determine whether the blank space size is larger than the threshold value Th (S204). The blank space size denotes the width of the blank space portion. When the blank space size is larger than the threshold value Th, a ground pattern period is determined in accordance with the information from the region discriminator 144 (S206). When the ground pattern period is smaller than the blank space size (YES at S208), the ground pattern period is set at the current period (S210). However, when the ground pattern period is larger than the blank space size (NO in S208), the ground pattern period is set in accordance with the blank space size (S212). Specifically, the repetitive period of the ground pattern is increased so that the character pattern of the ground pattern can be reproduced within the blank space. When the blank space size is smaller than the threshold value Th (NO at S204), the density of the ground pattern detected by the ground pattern detector 142 is decreased (S214), the ground pattern density is inverted in the image portion (S216), and the ground pattern having the repetitive period is output (S218).

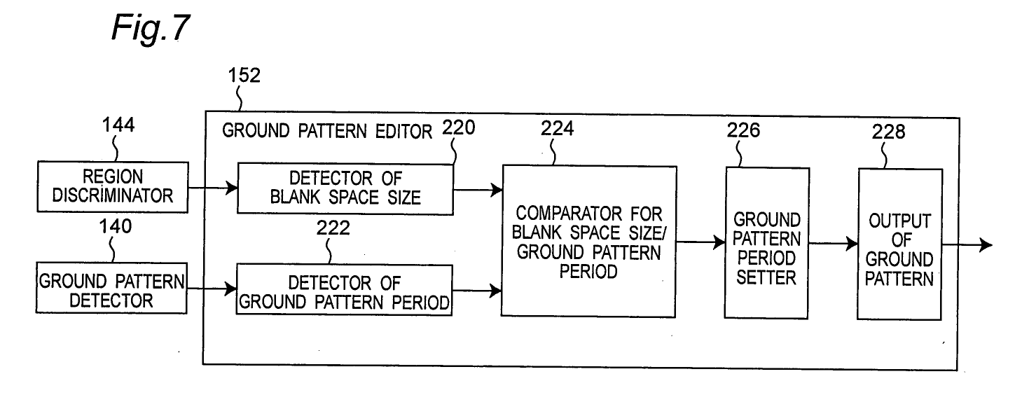

FIG. 7 shows a configuration of the ground pattern editor 152 for performing the processing shown in FIG. 6. A blank space size detector 220 determines the blank space size in accordance with the result of the region determination received from the region discriminator 144, and a ground pattern period detector 222 detects the ground pattern period in accordance with the information from the ground pattern detector 140. A blank space size/ground pattern period comparing portion 224 receives and compares those values with predetermined values to outputs the comparison results. A ground pattern period setter 226 converts if necessary and sets the period of the ground pattern. A ground pattern outputter 228 outputs the ground pattern in accordance with an instruction from the setter 226.

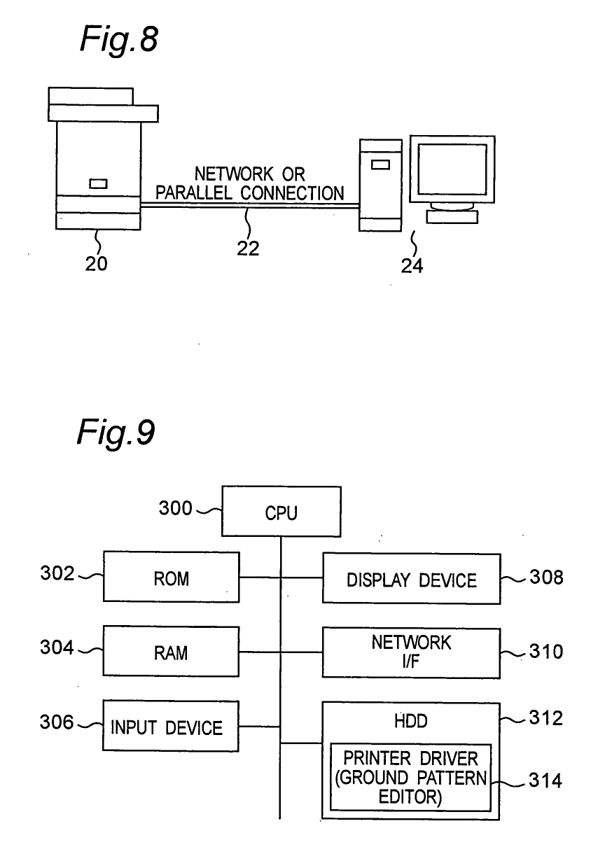

Next, a third embodiment of the invention is described with reference to FIGS. 8 to 10. In the above-mentioned first and second embodiments, a ground pattern has been synthesized with a document in an original, and the ground pattern is edited when it is detected in a print of the original on copying, fax transmission or scanning. However, in the third embodiment, a ground pattern to be synthesized with an image of a document is edited when an original for the document is printed.

In a system shown in FIG. 8, a multi-functional peripheral (MFP) 20 functioning as a printer, a scanner or a copying machine is connected to an information processing terminal 24 such as a computer through a network 22 such as a local area network or in parallel connection. A user of the information processing terminal 24 can instruct the MFP 20 to read or print an image. The MFP 20 prints an original in accordance with the data transmitted from the information processing terminal 24.

FIG. 9 shows a configuration of the personal computer (PC) as an example of the information processing terminal 24. The computer has a central processing unit (CPU) 300 for executing programs. The CPU 300 is connected to a read-only memory (ROM) 302 for storing programs and data, a random access memory (RAM) 304 serving as a work area, an input device 306 such as a keyboard and a mouse to be operated by a user, a display device 308 for displaying information on a screen, a network interface 310 to be connected to the network, and a hard disk drive 312 serving as a storage device. This configuration is similar to that of a conventional personal computer. A printer driver 314 is stored in the hard disk drive 312, and a ground pattern editor is included in the printer driver 314.

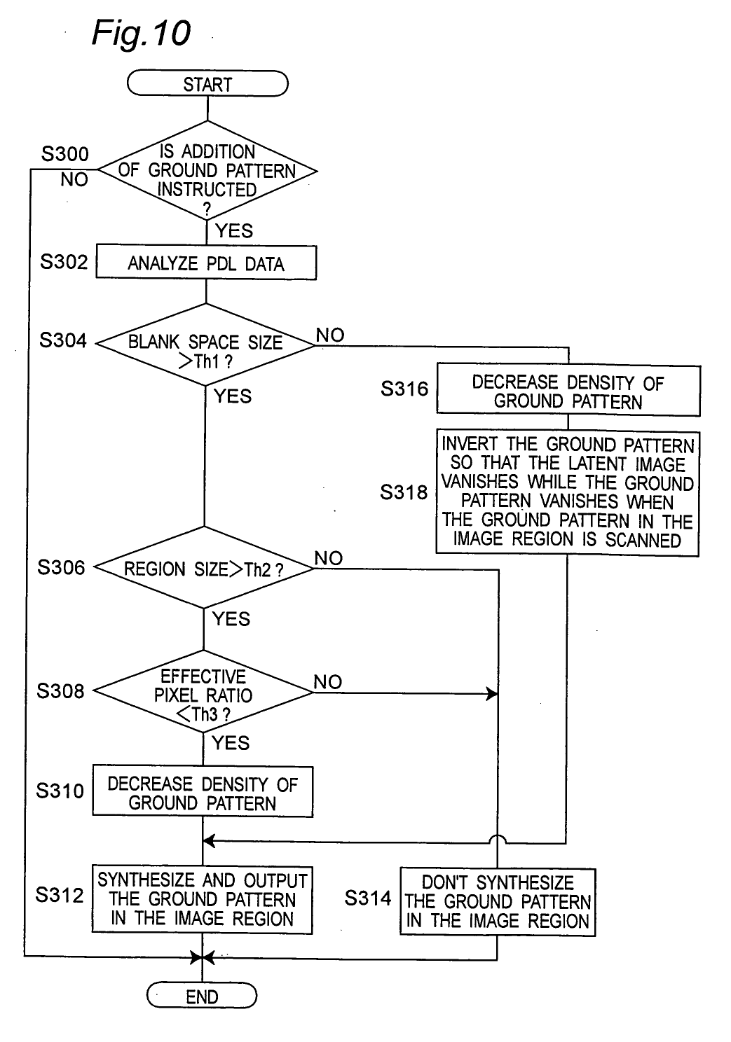

FIG. 10 shows a flow of the ground pattern editor in the third embodiment. The ground pattern edition is started when addition of a ground pattern is instructed by the printer driver 314 (YES at S300). First, page description language (PDL) data which is print data is analyzed, and blank space size, image region size, and effective pixel ratio are determined (S302). (Various known techniques can be used in order to detect the blank space portion and the effective pixels.) Moreover, when the blank space size is larger than a threshold value Th1 (YES at S304), it is determined next whether the image region size is larger than a threshold value Th2 (S306). When the image region size is larger than the threshold value, it is determined further whether the effective pixel ratio is smaller than a threshold value Th3 (S308). When the effective pixel ratio is smaller than the threshold value Th3 (YES at S308), the density of the ground pattern is decreased (S310). The ground pattern is synthesized in the image region (S312). When the effective pixel ratio is larger than the threshold value Th3 (NO at S08) or the region size is smaller than the threshold value Th2 (NO at S306), the ground pattern is not synthesized in the image region of an original, and an original is output (S312). When the blank space size is smaller than the threshold value Th1 (NO at S304), the density of the ground pattern is decreased (S316), and the ground pattern is inverted so that when the image is scanned, a latent image in the ground pattern vanishes while the pattern around the latent image remains (S318). Then, an original is output (S312).

In the third embodiment, an original is output by editing and synthesizing a ground pattern in accordance with an image region when the original is prepared. Therefore, the ground pattern edition is not necessary to meet the specifications of the MFP for the ground pattern detection and for the ground pattern edition for scanning the original. Even if an original is scanned by any model, it is possible to make the ground pattern noticeable as intended by a user, and the effect for refraining illegal prints is enhanced.

In the embodiment, the ground pattern editor is included in the print driver 314. Alternatively, the ground pattern editor is provided in the MFP 20, and a ground pattern is edited in accordance with a command from the print driver 314.

In this embodiment, reproduction of an original is described. Moreover, the present invention can be applied to scanning of an original for fax transmission thereof, or scanning of an original to create an electronic file.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. An image processing apparatus comprising:
an input device which inputs image data;
a region separator for separating image regions in the image data in accordance with a feature of the input image; and
a ground pattern editor which edits a ground pattern to be added to the image data in accordance with region information on each of the image regions separated by said region separator.

2. The image processing apparatus according to claim 1, further comprising a ground pattern detector which detects the ground pattern in the input image data, wherein said ground pattern editor edits the ground pattern by using the ground pattern detected by said ground pattern detector and the region information for each of the image regions separated by said ground pattern separator.

3. The image processing apparatus according to claim 1, further comprising an output device which synthesizes the ground pattern edited by said ground pattern editor with the input image and outputs the synthesized image.

4. The image processing apparatus according to claim 1, wherein the region data includes a size of each of the separated image regions.

5. The image processing apparatus according to claim 1, wherein said region separator further detects region size of and effective pixel dot ratio in each of the separated image regions.

6. The image processing apparatus according to claim 1, wherein said ground pattern editor changes a period of the ground pattern in accordance with a size of each of the separated image regions.

7. The image processing apparatus according to claim 1, wherein said ground pattern editor performs the edition in accordance with a size of a blank space or an effective pixel ratio in each of the image regions.

8. The image processing apparatus according to claim 7, wherein said ground pattern editor adds the ground pattern to a blank space when the blank space is larger than a first predetermined value, it adds the ground pattern with a decreased density than the density in the input image data to an image region having a size larger than a second predetermined value when the effective pixel ratio in the image region is smaller than a third predetermined value, it does not add the ground pattern to the image region when the effective pixel ratio is equal to or larger than the third predetermined value, and it does not add the ground pattern to an image region having a size equal to or smaller than the second predetermined value.

9. The image processing apparatus according to claim 2, wherein said ground pattern detector separates a ground region from the other region and analyzes the ground region to decide whether a previously registered ground pattern is present or not in the ground region.

10. The image processing apparatus according to claim 9, wherein information on the previously registered ground pattern includes color information on a pattern to be used as the ground pattern and parameters for emphasizing the ground pattern.

11. An image processing method comprising:
inputting an image data;
separating regions in the image data in accordance with a feature of the input image; and
editing a ground pattern to be added to the image data in accordance with region information on each of the separated regions.

12. The image processing method according to claim 11, further comprising detecting the ground pattern from the input image data, wherein the ground pattern is edited based on the detected ground pattern and the region information on each of the separated regions.

13. The image processing method according to claim 11, further comprising synthesizing and outputting the edited ground pattern with the input image.

14. A computer-executable image processing program comprising the steps of:
inputting an image data;
separating regions in the image data in accordance with a feature of the input image; and
editing a ground pattern to be added to the image data in accordance with region information on each of the separated regions.

15. The image processing program according to claim 14, further comprising the step of detecting the ground pattern from the input image data, wherein the ground pattern is edited based on the detected ground pattern and the region information on each of the separated regions.

16. The image processing program according to claim 14, further comprising the step of synthesizing and outputting the edited ground pattern and the input image.

17. The image processing program according to claim 13, further comprising the step of synthesizing and outputting the edited ground pattern and the input image.
